(19) United States
(12) Patent Application Publication
(10) Pub. No.: US 2007/0144690 A1
(43) Pub. Date: Jun. 28, 2007

(54) Roller blind with simplified assembly of the wind-up shaft

(75) Inventors: Isidor Heinrich, Esslingen (DE); Harald Kerzbeck, Esslingen (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co. KG, Ostfildern (DE)

(21) Appl. No.: 11/640,567

(22) Filed: Dec. 18, 2006

(30) Foreign Application Priority Data
Dec. 28, 2005 (DE) 102005062973.3

(51) Int. Cl. B60J 1/20

(52) U.S. Cl. 160/370.22

(57) ABSTRACT

A window roller blind, especially a sunroof roller blind, having a wind-up shaft which is rotatably supported at one end on a bearing piece. The bearing piece is provided with a flat-sided pin, which is inserted into a slot that is open on one end. Through the force of a spring motor coupled to the bearing piece and used for returning the roller blind to a rolled-up condition, the pin is held against a closed end of the slot permanently and rattle-free.

### FIELD OF THE INVENTION

The present invention related generally to roller blinds, and more particularly, to roller blinds used to shade motor vehicle windows and sunroofs.

### BACKGROUND OF THE INVENTION

Window roller blinds in motor vehicles are now no longer used just in the upper price class vehicles. They are also increasingly being used in middle and low price vehicles, which means that design engineers must be particularly concerned with reducing assembly costs.

Window roller blinds in motor vehicles have a flexible shade-like roller-blind body, which is fixed at one edge to a wind-up shaft. The contour of the roller-blind body corresponds approximately to a the window area to be shaded.

Spring motors usually are used in order to wind the roller-blind body back onto the wind-up shaft. Typically, these spring motors are relatively long coil springs that are used as torsion springs. One end of the coil spring is fixed in the wind-up shaft, while the other end is attached to the car body via a bearing pin of the wind-up shaft.

This type of wind-up shaft pre-tensioning is used for both manual roller blinds and electrically operated blinds. For electrically operated roller blinds, a pull-out rod or profile is guided on its ends in guide rails for movement back and forth with the aid of a gear motor which operates a Bowden cable-like arrangement. Assembly of the wind-up shaft can be cumbersome and time consuming, and hence, can appreciably affect the cost of the roller blind.

### OBJECTS AND SUMMARY OF THE INVENTION

It is an object of the invention to provide a roller-blind arrangement in which assembly of the wind-up shaft is simplified, reliable and efficient.

The roller-blind arrangement has a shade-like roller-blind body, whose contour is adapted to the window to be shaded. The pull-out profile is fixed to one edge of the roller-blind body, while the wind-up shaft is attached to the other edge. In the wind-up shaft there is a spring motor, which is anchored to the wind-up shaft with its end lying in the wind-up shaft. For rotatably supporting the wind-up shaft, a bearing piece is provided to which the other end of the spring motor is fixed. This bearing piece has a profiled pin projecting from the wind-up shaft.

A holder in the car body or an intermediate frame has a slot that is open at one end. The width of the slot is adapted to the thickness of the projecting pin, which is flattened on the sides and which is locked against rotation in the slot by its flattened sections. At the end of the slot there is a stop, which is aligned so that the pin is held against a stop surface by the restoring force created in the roller-blind body by the spring motor. The other end of the wind-up shaft can be supported in the same way, or alternatively, can also have a simple symmetric rotatable pin which is inserted into a stationary bearing aperture or borehole.

In this way, the assembly of this roller blind is significantly simplified because it is sufficient to place the pin into the borehole in assembling the wind-up shaft and to insert the flat pin into the slot. Due to the spring motor effectively being connected to the pull-out profile, the wind-up shaft is fixed in the region of the slot. Additional attachment means are not necessary. The anchoring according to the invention for the wind-up shaft is especially advantageous when the wind-up shaft bearing is not easily accessible from the side due to constrained spatial relationships.

A roller-blind arrangement equipped with such a wind-up shaft can be operated manually or electrically. In the first case, it is sufficient to provide an appropriate handle on the pull-out profile. In the other case, guide rails can be provided between which power operated movement of the pull-out profile is guided. For driving an electric roller blind, known arrangements may be employed. These typically consist of cable or Bowden-cable pulling arrangements which are guided in the guide rails and are set into motion by a linear drive.

An especially secure holding of the projecting pin is achieved when the slot has an angled profile. The angled region has a length or depth that corresponds to the larger cross-sectional dimension of the pin. This also guarantees an especially rattle-free holding. Another possibility for holding the pin securely is to provide at the end of the slot an opening that is composed equally from two sectors lying diametrically opposite each other. The flattened pin engages in these sections and is held so that it is practically impossible to disassemble.

The assembly can be further simplified when a locking or blocking device, which is permanently disengaged after assembly, is used with the spring motor. Such a blocking device can be comprised, for example, of aligned boreholes in the bearing piece and in the wind-up shaft in which a mandrel is inserted, which blocks rotation of the bearing piece relative to the wind-up shaft due to the coil spring receiving the pre-tensioning force. Other blocking devices of a known type also could be used.

It will be appreciated that the invention is particularly useful in sunroofs of sedans.

Other objects and advantages of the invention will become apparent upon reading the following detailed description and upon reference to the drawings, in which:

### BRIEF DESCRIPTION OF THE DRAWING(S)

FIG. 1 is a fragmentary top plan view of a motor vehicle having a sunroof with a roller blind in accordance with the invention;

FIG. 2 is an enlarged plan view, in partial section, of the illustrated roller blind;

FIG. 3 is an enlarged, exploded fragmentary perspective of the windup shaft and a windup shaft holding mechanism of the illustrated roller blind,

FIG. 4 is a side view illustrating the holding pin of the illustrated windup shaft in mounted position; and

FIG. 5 is a side view, similar to FIG. 4, showing an alternative form of slot for holding the windup shaft.

While the invention is susceptible of various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

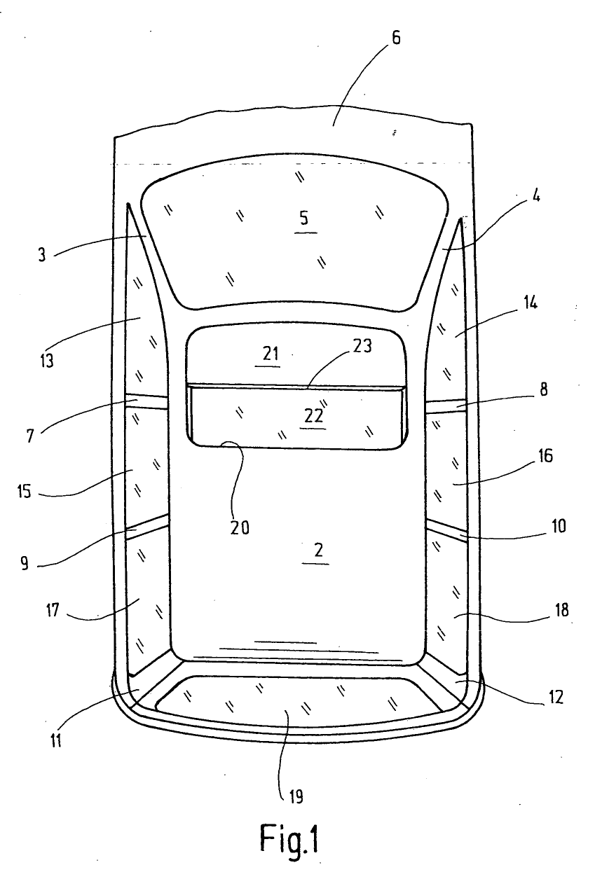

Referring now more particularly to FIG. 1 of the drawings, there is shown a motor vehicle having a sunroof roller blind in accordance with the invention. The motor vehicle in this case is a station wagon 1 having a sunroof 2, from which two A-columns 3, 4 project at a front end. Between the two A-columns 3, 4, there is a windshield 5, which transitions at the lower edge into a radiator cover or hood 6. Backwards from the two A-columns 3, 4 are B-columns 7, 8, C-columns 9, 10, and D-columns 11, 12. Between the columns 3 . . . 12, front side windows 13, 14, rear side windows 15, 16, and side windows for the trunk space 17, 18 can be seen. The end has a rear window 19 which is provided between the two D-columns 11, 12.

A roof opening 20, in which a sunroof 21 is located, is contained in the front region of the roof 2 bordering the front window 5. The sunroof 21 can be a glass roof that slides or is raised, or which can combine the two functions with each other.

Underneath the glass roof 21, a roller-blind arrangement or assembly 24 is provided which has a roller-blind body or shade 22 shown in FIG. 1 in a partially extended condition. The roller-blind body 22 is fixed at one edge to a pull-out profile or rod 23 and at the opposite edge to a wind-up shaft 25. The illustrated roller blind arrangement includes a gear motor 26 and two guide rails 27, 28 disposed on opposite sides of the roller blind body.

The guide rails 27, 28 run parallel to the corresponding adjacent side edges of the sunroof 21, which has an approximately rectangular shape. For visual reasons, in practice, the two guide rails 27, 28 are integrated into the top of the roof of the vehicle 1 so as to be as inconspicuous as possible. The two guide rails 27, 28 are constructed as mirror images to each other so that it is sufficient to explain the construction of the guide rail 28 in detail, which will similarly apply to the other. The guide rail 28 includes a guide groove 29, which as viewed in cross section has a groove chamber 31 and a groove slot 32. The groove slot 32 faces in the direction of the opposite guide rail 27.

The pull-out profile 23 includes a middle piece 33 which has a fixed length and two endpieces 34, 35 that can move in a telescoping relation to the middle piece 33. The width of the middle piece 33 corresponds to the width of the rectangular outline of the roller-blind body 22, which in turn is adapted to the width of the sunroof 21 in order to allow the sunroof 21 to be shaded over the entire width as much as possible. Because the two guide rails 27, 28 run parallel to each other, the amount of movement of the two endpieces 34, 35 can be small in order to compensate primarily for parallel and assembly tolerances between the two guide rails 27, 28. The sliding piece 37 has a cross section such that it can slide without jamming in the groove chamber 31.

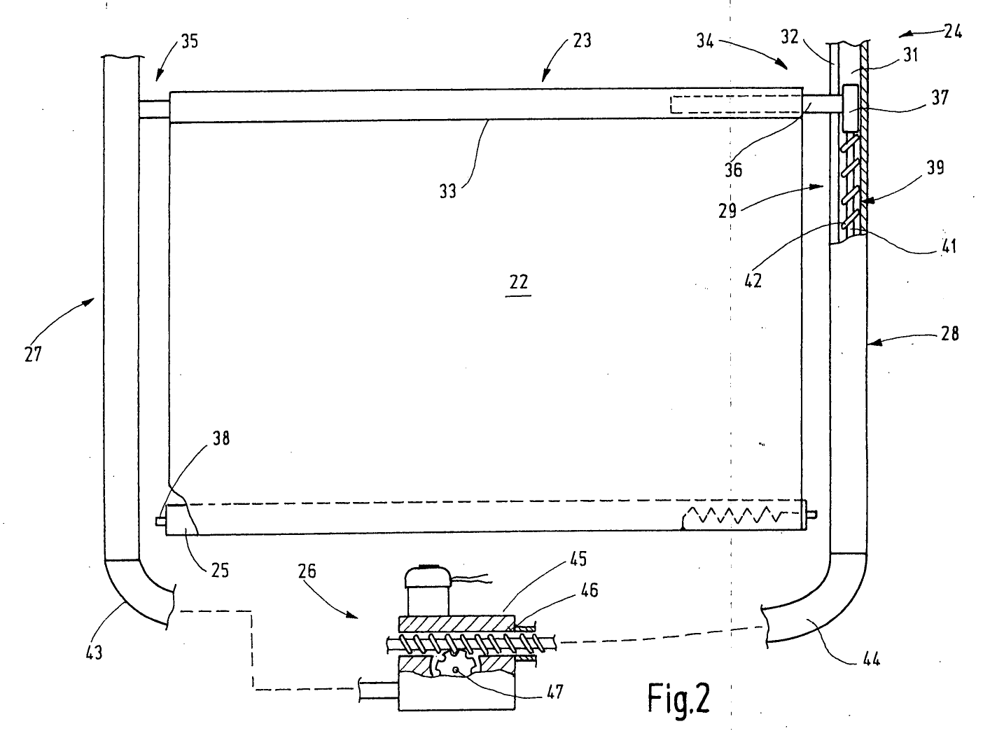

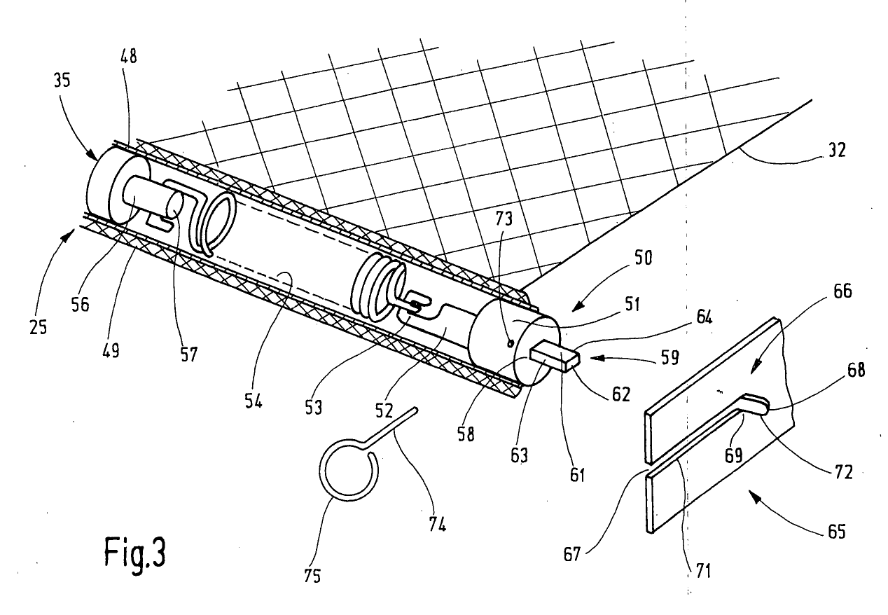

The wind-up shaft 25 is supported at a rearward end of the sunroof. The shaft 25 has a pin 38 rotatably supported in a cylindrical borehole of an appropriate holder in a know way, as depicted in FIG. 2. The bearing for the other end of the wind up shaft is depicted in FIG. 3 and will be described below.

To transfer the driving force from the gear motor 26 to the pull-out profile 23, a bend resistant guided pushing element 39 is located in the guide chamber 31 of each guide rail 27, 28. The pushing elements 39 are flexible and are assembled from a circular cross section core 41 and a spiral 42 attached to this core. On the outside of the core 41, the spiral 42 forms teeth running diagonal over the length. In other words, the pushing element 39 effectively is a flexible toothed rack with teeth all around. At its free end, each pushing element 39 contacts the adjacent end of the sliding piece 37. The two pushing elements 29 are moved, by means of the gear motor 26, through guide tubes 43, 44 between the gear motor 26 and the bottom ends of the guide rails 27, 28. The gear motor 26 has a gear housing, through which two bore holes extend in parallel relation to each other, only one of which can be seen in FIG. 2. The boreholes 46 extend tangentially past an output gear 47, which engages in the teeth of the two pushing elements 39.

Because the two pushing elements on diametrically opposite sides mesh with the same output gear 47, they are each moved in the opposite direction by equal amounts when the output gear 47 is rotated. The extra length of each pushing element 39 extends into an appropriate storage tube.

The right end of the wind-up shaft 25 is supported by a holder, as depicted in FIG. 3. The wind-up shaft 25 comprises a continuous, essentially cylindrical tube, which optionally has an appropriate continuous weather-strip groove for attaching an end of the roller-blind body 22 in such groove. However, such weather-strip groove or other measures for attaching the roller-blind body are not shown in the drawing because these are not essential for understanding the invention. Therefore, the representation is limited to a simplified illustration of the wind-up shaft 25 which has the shape of a simple, smooth, continuous cylindrical tube 48. Furthermore, all of the parts that secure the wind-up shaft 25 in an axial direction are omitted because these are also not important for understanding the invention. In the wound up state, it will be understood that the roller-blind body 22 is wound around the tube 48 of the wind-up shaft 25 to form a more or less thick roll body 49.

As can be seen from FIG. 3, a cylindrical bearing piece 50 with a cylindrical outer peripheral surface 51 is placed in the wind-up shaft tube 48 for supporting this tube. The outer peripheral surface 51 of the bearing piece 50 fits in the wind-up shaft tube 48 so that the wind-up shaft tube 48 can rotate freely on the essentially cylindrical bearing piece 50. The bearing piece 50 has a pin 52 extending into the tube 48 which carries a hook 53. A coil spring 54, which is used as a spring motor, has one end fixed to the hook 53. The coil spring 54 serves to pre-tension the wind-up shaft 25 relative to the bearing piece 51 in the sense of winding the roller-blind body 22 onto the wind-up shaft 25.

To transmit the torque from the coil spring 54 to the wind-up shaft tube 48, a stop piece 55, which is fixed for rotation with the wind-up shaft tube 48, for example, by stamping beads, sits deep in the wind-up shaft tube 48. The stop piece 55 carries a pin 56 with a hook 57 on its free end, similar to hook 53. The other correspondingly angled end of the coil spring 54 is fixedly set in this hook 57.

An outer side 58 of the bearing piece 51 faces axially outwardly from the wind-up shaft tube 48 and carries an anchoring or attachment pin 59 coaxial to the outer peripheral surface 51. The attachment pin 59 has two flat sides 61, 62, which run parallel to each other and which lie symmetric to the longitudinal axis of the pin 59 and the wind-up shaft tube 48. Partially cylindrical, curved side surfaces 63, 64 extend at opposite ends between the flat sides 61, 62. The distance between the two side surfaces 63, 64 is significantly larger than the distance between the two flat sides 41, 42 from each other. Each flat side defines a flat surface. In this way, a flat edge is formed, which is to be mounted so that it does not rotate.

A stop for the anchoring pin 59 is, for example, a plate shaped bracket 65, which is fixed in the motor vehicle and which is formed with a receptacle slot 66. The receptacle slot 66 is open at one end 67 and closed at an end 68. From the open end 67, the gap-shaped slot extends a short distance into the bracket 65 up to a transition point 69. At the transition point 69, the gap-shaped slot 66, bends as shown by approximately 45° diagonally downwardly. The transition point 69 thus divides the entire gap-shaped slot into a first section 71 and a second angled section 72.

The width of the slot 66 corresponds to the distance between the two flat sides 61, 62 of the attachment pin 59. The pin 59 can thus be pushed from the open end 67 into the slot section 71, without it being allowed to rotate. At the transition point 69, the slot geometry is shaped so that at that point the anchoring pin 59 can rotate slightly about its longitudinal axis in order to be moved into the angled slot section 72. When it is located in the angled slot section 72, it contacts the closed end 68 of the slot section 72, for example, with the side surface 64, while the opposite side surface 63 essentially contacts the opposite wall of the slot section 71.

In order that during assembly the spring motor does not lose tension if not desired, a blocking device is also provided. For this purpose, a known type of blocking device can be used, like those that the applicant uses in other applications and for which the applicant has created a corresponding state of the art. Therefore, in the present case the explanation of the blocking device is limited to a relatively simple variant that is similarly used.

The blocking device is effective for preventing rotation of the wind-up shaft tube 48 relative to the bearing piece 50 during assembly and prior to usage of the roller blind. For this purpose, the bearing piece 50 is formed with a borehole 78 in the outer cylindrical side adjacent the outer end side 58 which is aligned in one rotational position of the wind-up shaft tube 48 with a corresponding borehole in this tube. It will be understood that due to the cutaway representation in FIG. 3, the corresponding borehole in the wind-up shaft tube 48 cannot be seen. For blocking relative rotation between the bearing piece 50 and the wind-up shaft tube 48, an elongated pin 74 is provided, that has a handle 75. In the blocking state, the pin 74 extends through both boreholes of the bearing piece and wind-up shaft tube.

FIG. 4 shows in a side view the relative position between the anchoring pin 59 and the plate 66 when the wind-up shaft 25 is mounted.

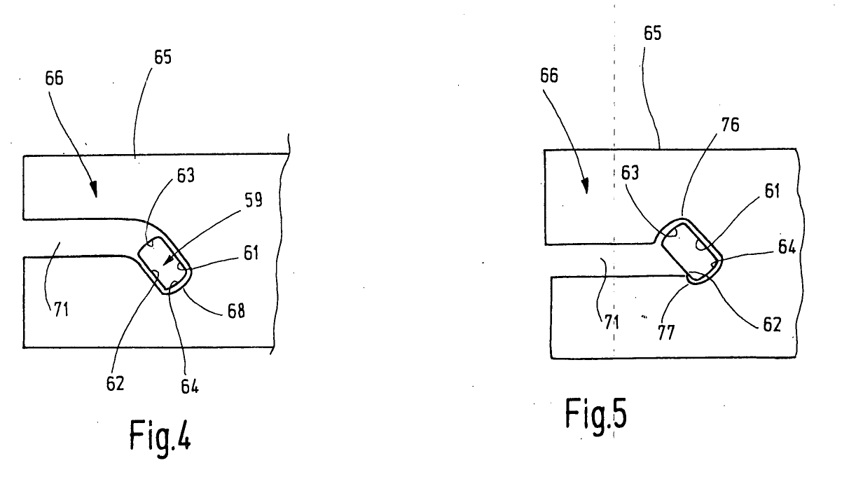

FIG. 5 shows an alternative embodiment of the plate 66. As can be seen, the slot section 71 in this embodiment ends in an opening, which has the contours of the cross section of the anchoring pin 59, wherein the longer axis of the cross-sectional profile is tilted relative to the longitudinal axis of the slot section 71. The axis is set so that the flat side 62 of the anchoring pin 59 contacts a transition shoulder 77, which is produced at the transition from the slot section 71 to the opening 76, due to the pre-tensioning of the spring 54.

The assembly of the described roller blind arrangement is basically as follows: After attaching the roller-blind body 22 to the wind-up shaft tube 48, the spring 74 is tensioned by turning the previously mounted bearing piece 50, such that the wind-up shaft tube 48 attempts to turn opposite the bearing piece 50 in the sense of winding up the roller-blind body 22.

After the correct pre-tensioning is achieved, the borehole in the wind-up shaft tube 48 and the borehole 73 in the bearing 50 are aligned with each other, and the securing pin 74 is inserted. For assembly in the vehicle or in a correspondingly prepared assembly frame, which is inserted as a whole, in order to assemble the wind-up shaft 25, the pin 38 is inserted into the associated bearing borehole at first with the wind-up shaft 25 diagonally oriented. Then, at the other end of the wind-up shaft, the anchoring pin 59 is inserted from the open slot end 67 in the plate 66 until it enters into the slot section 72 through slight rotation of the wind-up shaft. As soon as this position is reached, the securing pin 74 is pulled out, which releases the spring motor.

The roller-blind body can now be pulled from the wind-up shaft, as the sliding pieces 37 are moved into the free ends of the guide rails 27, 28. Due to the pre-tensioning of the coil spring 54, in each position the anchoring pin 59 is held in the slot section 72 with its edge at the end of the slot. Because the slot width is adapted to the distance of the two flat sides 61, 62 and is smaller than the distance between the two side surfaces 63, 64, the anchoring pin 59 cannot rotate in the section 72. This same situation occurs in the arrangement shown in FIG. 5.

It will be understood the bearing arrangements for the right end of the wind-up shaft 25, as viewed in FIGS. 4 and 5, can also be used on the other end of the wind-up shaft instead of the cylindrical pin 38. Furthermore, it can be seen by one skilled in the art that the above described roller-blind arrangement is not limited to sunroofs. Indeed, the roller-blind arrangement can be similarly used on all of the other windows of a motor vehicle.

From the foregoing, it can be seen that a window roller blind is provided, which is especially useful as a sunroof roller blind, that has a wind-up shaft rotatably supported in a unique bearing piece to which the spring motor for pre-tensioning the wind-up shaft is anchored. The bearing piece is provided with a flat-sided pin, which is inserted into a slot that is open on one end. Through the force of the spring motor, the pin is held permanently and rattle-free against the closed end of the slot in predetermined position, thereby lending itself to easy, reliable and efficient assembly

1. A roller-blind arrangement (24) for a window of a motor vehicle comprising:
a flexible roller-blind body (22),
a pull-out profile (23) fixed to one edge of the flexible roller-blind body (22),
a wind-up shaft (25) fixed to another edge of the roller-blind body (22) opposite said one edge,
a spring motor (54) housed in said wind-up shaft (25) and having one end anchored to said wind-up shaft,
a bearing piece (50) rotatably supporting said wind-up shaft (25),
said spring motor (54) being anchored to one end of said bearing piece (50), said bearing piece (50) having a pin with a non-circular cross-sectional profile projecting outwardly from the wind-up shaft (25),
a holder (65) mountable in a motor vehicle (1) formed with a slot (66, 71) that has a closed end (68, 76) and an open end (67),
said slot (66, 71) having a width corresponding to a narrow thickness of the said profiled pin (59), and
said pin (59) and slot (66, 71) having respective cross-sectional profiles such that upon positioning of said pin into said slot the holder slot acts as stop to prevent relative rotational movement of the pin (59) in to the slot (66, 71) under the force of said spring motor (54).

2. The roller blind of claim 1 in which said slot has a closed end that forms a stop against which an end of the non-circular pin is held under the force of the spring motor.

3. The roller blind of claim 2 in which said stop is oriented in the direction of the path of movement of said roller blind body (22).

4. The roller blind of claim 1 in which said slot defines a stop (68, 76) oriented in the direction of the path of movement of the flexible roller blind body (22) when the roller blind body is pulled out against the effect of the spray motor (54) such that the pin is held in the slot (66) against the stop (68, 76) by the pretensioning of the spring motor.

5. The roller blind of claim 1 in which pin has an elongated cross section with flat parallel sides which are larger in length than the transverse width of the pin, and said stop being defined by a closed-end of said slot against which one end of said pin extending transversly to said flat parallel sides is held by the force of said spring motor.

6. The roller blind of claim 1 including a stop device (39) for the pull-out profile (23) that cannot be overcome by the spring motor (54) and that limits drawing end movement of the roller blind body (22) onto the wind-up shaft.

7. The roller blind of claim 1 in which a similar said bearing piece (50) and holder (65) are provided for supporting opposite ends of said windup shaft (25).

8. The roller blind of claim 1 in which an end of said windup shaft opposite that in which said bearing piece is disposed has an axial pin (38) supported within a circular bearing hole of a support member.

9. The roller blind of claim 1 in which said flexible roller blind body (22) has an outline corresponding to the shape of a sunroof window.

10. The roller blind of claim 1 in which said flexible roller blind body (22) has an outline corresponding to the shape of a side window of a vehicle.

11. The roller blind of claim 1 including guide rails (27, 28) disposed on opposite sides of the roller blind body (22) for guiding movement of the pull-out profile (23).

12. The roller blind of claim 11 in which said pull-out profile is adjustable in axial length.

13. The roller blind of claim 1 including an electric motor powered drive for moving said pull-out profile (23) away from the windup shaft (25) against the force of the spring motor (54).

14. The roller blind of claim 11 in which said holder (65) is connected to one of said guide rails (28).

15. The roller blind of claim 1 in which said pin (59) has a cross section that defines two parallel flat sides (61, 64) and ends (63, 64) lying transverse to the sides (61, 64), and the distance between the flat sides (61, 62) is smaller than the distance between said ends (63, 64).

16. The roller blind of claim 15 in which the ends (63, 64) are rounded.

17. The roller blind of claim 1 in which said pin has an elongated cross sectional profile, and said slot (66) having a first slot section (71) with an open end (67) and a second relatively-shorter slot section (72) angled relative to the first slot section (71), and said relatively-short slot section (72) having a length corresponding to a long axis of the elongated profile of said pin (59).

18. The roller blind of claim 17 in which the first slot section (71) communicates with said second slot section (72) at a location intermediate its ends such that opposite ends of the second slot section (72) are disposed are opposite sides of the first slot section (71).

19. The roller blind of claim 1 including a detachable blocking device (73, 74) for preventing relative rotation of the windup shaft on the bearing piece (51).

20. The roller blind of claim 20 in which the blocking device includes a removable pin (74) that is positionable into aligned openings formed in the bearing piece (50) and windup shaft (25).
